(19) United States
(12) Patent Application Publication
(10) Pub. No.: US 2007/0086149 A1
(43) Pub. Date: Apr. 19, 2007

(54) Plasma display device

(76) Inventor: Young-Oh Choi, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/581,408

(22) Filed: Oct. 17, 2006

(30) Foreign Application Priority Data
Oct. 18, 2005 (KR) 10-2005-0098014

(51) Int. Cl. H02B 1/00

(52) U.S. Cl. 361/600

(57) ABSTRACT

A plasma display device includes a plasma display panel, a chassis base coupled to the plasma display panel, a driving board having a plurality of circuit elements and mounted on the chassis base to supply driving voltage, and at least one reinforcement member mounted on the driving board.

### BACKGROUND OF THE INVENTION

1. Field of the Invention

The present invention relates to a plasma display device. More particularly, the present invention relates to a plasma display device having a driving circuit structure with an improved stability.

2. Description of the Related Art

In general, a plasma display device refers to a flat display device which uses a plasma display panel (PDP) to display images using gas discharge phenomenon. The plasma display device may include a PDP having two substrates with a plurality of discharging electrodes, a chassis base to support the PDP, and at least one driving board with circuit elements to drive the PDP.

Larger plasma display devices may require more circuit elements and, thereby, larger driving boards for their support. A larger size of a driving board and an increased number of circuit elements may generate stress due to the weight of the circuit elements, and, consequently, bend the driving board and/or weaken its attachment to the PDP via the chassis base, e.g., loosen a bolt connection. A bent and/or weak driving board may provide poor support for circuit elements and increase peeling of solder, thereby triggering malfunctioning of the plasma display device. Additionally, unstable driving boards may trigger vibrations and, thereby, generate noise.

Accordingly, there exists a need to improve the structure of the driving board in the plasma display device in order to provide sufficient stability thereto and maintain proper electrical operation of the plasma display device.

### SUMMARY OF THE INVENTION

The present invention is therefore directed to a plasma display device, which substantially overcomes one or more of the disadvantages of the related art.

It is therefore a feature of an embodiment of the present invention to provide a plasma display device having a driving board structure with an improved stability.

It is therefore another feature of an embodiment of the present invention to provide a plasma display device having a driving board structure capable of providing a signal with an improved stability.

At least one of the above and other features and advantages of the present invention may be realized by providing a plasma display device, having a plasma display panel, a chassis base coupled to the plasma display panel, a driving board with a plurality of circuit elements and mounted on the chassis base, and at least one reinforcement member mounted on the driving board. The reinforcement member extends in one direction such that the driving board is prevented from bending.

The at least one reinforcement member may include a pair of first supporting members, such that the first supporting members may be parallel to one another. The reinforcement member may include a surface parallel to a planar surface direction of the driving board. The at least one reinforcement member may further include a pair of second supporting members. The first supporting members may have a length that is longer than a length of the second supporting members. Additionally, the pair of first supporting members and the pair of second supporting members may be arranged in a tetragon. The pair of first supporting members may be positioned in a plane perpendicular to a plane of the pair of second supporting members.

The pair of first supporting members may be parallel to a side of the driving board. Additionally, each of the first supporting members may be positioned along an edge of the driving board. Accordingly, a pair of second supporting members may be positioned on the driving board, such that the pair of second supporting members may be perpendicular to the pair of the first supporting members. A length of each of the first supporting members may be less than or about equal to a length of the edge of the driving board.

The reinforcement member may be positioned in a plane perpendicular to a plane of the driving board. Additionally, the reinforcement member may include a plurality of leg portions, wherein at least two of the plurality of leg portions may be positioned at respective ends of the reinforcement member and connected to the driving board. Further, at least one of the plurality of leg portions may be positioned between the respective ends of the reinforcement member.

The reinforcement member may also include at least one terminal portion coupled to at least one of the leg portions and electrically connected to the driving board. The reinforcement member may further include a separation space between the plurality of leg portions, the driving board, and a body of the reinforcement member.

Additionally, the reinforcement member may include a print circuit pattern. The print circuit pattern may be electrically connected to a ground via the driving board. Accordingly, the driving board may include a larger space for circuit elements as compared to a driving board without a reinforcement member.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic exploded rear view of a plasma display device according to an exemplary embodiment of the present invention;

FIG. 2 illustrates a schematic enlarged view of a reinforcement member on a driving board of a plasma display device according to an exemplary embodiment of the present invention;

FIG. 3 illustrates an enlarged view of a reinforcement member employed in the plasma display device illustrated in FIG. 1; and

FIG. 4 illustrates an enlarged view of an attachment of the reinforcement member illustrated in FIG. 3 to the plasma display device illustrated in FIG. 1.

### DETAILED DESCRIPTION OF THE INVENTION

Korean Patent Application No. 10-2005-0098014, filed on Oct. 18, 2005, in the Korean Intellectual Property Office, and entitled: “Plasma Display and Driving Device Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will also be understood that the figures are schematic in nature and the outlines and angles of regions and/or elements are not intended to limit the scope of the present invention to specific shapes. For example, a region illustrated as flat may have rough and/or nonlinear features. Similarly, angles illustrated as sharp may be rounded.

It will further be understood that when an element is referred to as being “on” another element or substrate, it can be directly on the other element or substrate, or intervening elements may also be present. Further, it will be understood that when an element is referred to as being “under” another element, it can be directly under, or one or more intervening elements may also be present. In addition, it will also be understood that when an element is referred to as being “between” two elements, it can be the only element between the two elements, or one or more intervening elements may also be present. In contrast, when an element is referred to as being “directly on,” there may be no intervening elements or layers present. Like reference numerals refer to like elements throughout.

As used herein, the term “and/or” may include any and all combinations of one or more of the associated listed items.

As further used herein, the singular forms “a,” “an” and “the” are intended to include the plural forms as well, unless the context clearly indicates otherwise.

Unless otherwise defined, all terminology used herein is given its ordinary meaning in the art, and therefore, should be interpreted within the context of the specification and the relevant art as understood by one of ordinary skill.

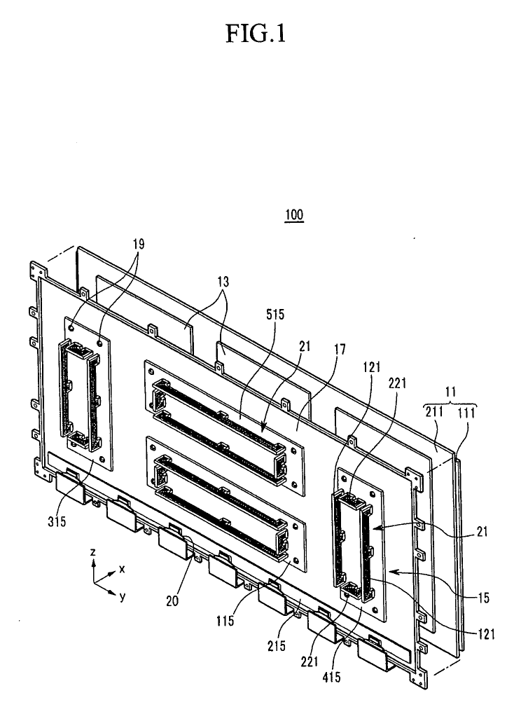

An exemplary embodiment of a plasma display device according to the present invention is more fully described below with reference to FIG. 1. As illustrated in FIG. 1, a plasma display device 100 according to an embodiment of the present invention may include a plasma display panel (PDP) 11, a chassis base 17, a driving board 15, and at least one reinforcement member 21.

The PDP 11 may include an upper substrate 111, a substrate board 211, a plurality of address electrodes (not shown), a plurality of display electrodes (not shown), and discharge cells (not shown) formed at intersections between the address electrodes and the display electrodes. Gas discharged from the discharging cells as a result of application of electricity to the electrodes may emit light to form images.

The plasma display device 100 according to an embodiment of the present invention may further include a double-coated tape (not shown) and a heat dissipation sheet 13 to diffuse heat generated by the PDP 11 along a direction of the yz-plane. In particular, the double coated tape may be adhered to at least one edge of the rear surface of the PDP 11 to attach the chassis base 17 thereto, such that the heat dissipation sheet 13 may be positioned therebetween, as illustrated in FIG. 1. The heat dissipation sheet 13 may be formed of any known acrylic heat-sinking material having good thermal conductivity, e.g., graphite, metal, carbon nanotubes, and so forth.

The chassis base 17 of the plasma display device 100 according to an embodiment of the present invention may be attached to a rear surface of the PDP 11. In other words, the chassis base 17 may be attached to a rear surface of the substrate board 211 of the PDP 11, such that the substrate board 211 may be positioned between the upper substrate 111 and the chassis base 17. The chassis base 17 may be formed of any known material having a good mechanical rigidity, e.g., iron, in order to provide sufficient support and protection to the PDP 11.

The driving board 15 of the plasma display device 100 according to an embodiment of the present invention may be disposed on a rear surface of the chassis base 17, such that the chassis base 17 may be positioned between the PDP 11 and the driving board 15. The driving board 15 may be attached to the rear surface of the chassis base 17 by at least one bolt 19. Additionally, the driving board 15 may be electrically connected to the electrodes of the PDP 11 via a flexible print circuit board (FPC board) and a connector in order to supply driving voltage thereto.

The driving board 15 may include a plurality of circuit elements for supplying and controlling the driving voltage of the PDP 11. For example, as illustrated in FIG. 1, the driving board 15 may include an image processing/controlling board 115, an address buffer board 215, a scan driving board 315, a sustain driving board 415, and a power source board 515. In particular, the image processing/controlling board 115 may receive an image signal, and, consequently, generate and transmit a corresponding control signal for driving an address electrode, a sustain electrode, or a scan electrode in the PDP 11, while the power source board 515 may supply the required power for driving the plasma display device 100.

More specifically, the control signal may be transmitted from the image processing/controlling board 115 to the address buffer board 215, the scan driving board 315, or the sustain driving board 415, such that each board may generate and transmit a corresponding pulse signal to a respective electrode. For example, the address buffer board 215 may generate a pulse signal corresponding to the control signal received from the image processing/controlling board 115 and transmit it to the address electrode. Similarly, the scan driving board 315 may generate and transmit a pulse signal to the scan electrode, and the sustain driving board 415 may generate and transmit a pulse signal to the sustain electrode.

Each circuit element of the driving board 15 may be mounted on the driving board 15, and may be electrically connected to other circuit elements and the PDP 11 by a PCB formed on the driving board 15. For example, as illustrated in FIG. 1, the address buffer board 215 may be connected to the address electrode of the PDP 11 via a FPC board 20.

The at least one reinforcement member 21 of the plasma display device 100 according to an embodiment of the present invention may be mounted on the driving board 15 in order to increase stability thereof, e.g., minimize bending of the driving board 15. In particular, the at least one reinforcement member 21 may be mounted along an edge of the driving board 15, such that the reinforcement member 21 may support both ends of the driving board 15 and, thereby, prevent the driving board 15 from bending or separating from the chassis base 17. More specifically, the at least one reinforcement member 21 may be attached onto the driving board 15 such that the at least one reinforcement member 21 may extend perpendicularly to a plane of the driving board 15. For example, as illustrated in FIG. 1, if the driving board 15 is positioned in the yz-plane, the at least one reinforcement member 21 may be positioned either in the xy-plane or in the xz-plane.

The at least one reinforcement member 21 may include at least one pair of first supporting members 121 or at least one pair of second supporting members 221. The pair of the first supporting members 121 may be parallel to one another, and the pair of the second supporting members 221 may be parallel to one another. The at least one reinforcement member 21 may include one pair of first supporting members 121 and one pair of second supporting members 221, wherein a length of the first supporting members 121 may be longer than a length of the second supporting members 221. If the pair of first supporting members 121 is positioned to extend in the xz-plane, the pair of second supporting members 221 may be positioned to extend in the xy-plane, such that the pair of first supporting members 121 and the pair of second supporting members 221 may be perpendicular to one another, e.g., form a tetragonal shape. Similarly, if the pair of first supporting members 121 is positioned to extend in the xy-plane, the pair of second supporting members 221 may be positioned to extend in the xz-plane.

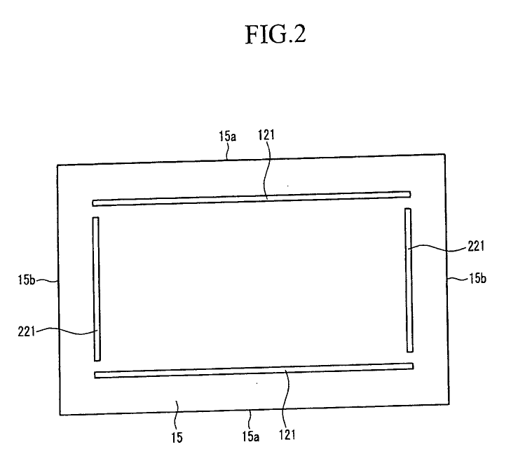

In detail, as illustrated in FIG. 2, the driving board 15 may include two long sides 15a and two short sides 15b, such that each short side 15b may be coupled between the two long sides 15a. Preferably, the two long sides 15a and the two short sides 15b may form a rectangle. For example, as illustrated in FIG. 2, the pairs of the first and second supporting members 121 and 221 may be arranged in parallel to the long sides 15a and the short sides 15b, respectively. Additionally, the first and second supporting members 121 and 221 may be positioned in close proximity to the edges of the driving board 15.

Without intending to be bound by theory, it is believed that the driving board 15 is likely to bend or separate from the chassis base 17 at its edges. Accordingly, when the pairs of the first and second supporting members 121 and 221 are attached in parallel to the long sides 15a and short sides 15b of the driving board 15 and in close proximity to the edges of the driving board 15, bending of the driving board 15 or its separation from the chassis base 17 may be minimized.

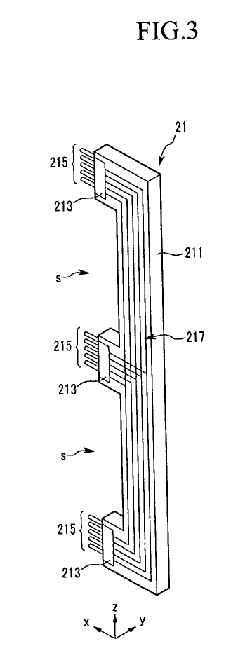

Each supporting member of either the pair of first supporting members 121 or the pair of second supporting members 221 of the reinforcement member 21 may include a body portion, a leg portion, a terminal portion, and a print circuit pattern. For example, as illustrated in FIG. 3, one supporting member of the pair of first supporting members 121 of the reinforcement member 21 according to an embodiment of the present invention may include a body portion 211, a leg portion 213, a terminal portion 215, and a print circuit pattern 217.

Preferably, the one supporting member of the pair of first supporting members 121 of the reinforcement member 21 may include a plurality of leg portions 213, e.g., three leg portions 213, that extend from the body portion 211 along the x-axis direction, as illustrated in FIG. 3, to facilitate connection between the reinforcement member 21 and the driving board 15. More specifically, a pair of leg portions 213 may be positioned at respective ends of the one supporting member 121 to provide connection points between the supporting member 121 and the driving board 15 and, thereby, supply sufficient support thereto. Additionally, another leg portion 213, i.e., a third leg portion, may be disposed between ends of the supporting member 121, e.g., center of the supporting member 121, to provide additional connection to the driving board 15 and support thereof.

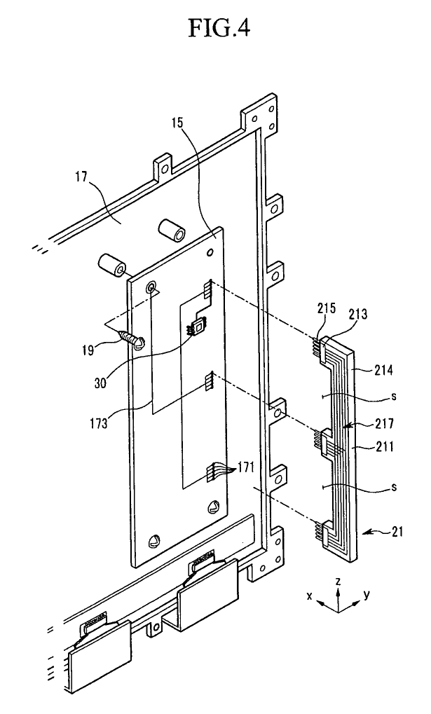

Each leg portion 213 may be attached to a terminal portion 215 to facilitate connection thereof to the driving board 15. Additionally, each leg portion 213 may have a predetermined length as measured from the body portion 211 along the x-axis, as illustrated in FIG. 3, such that when the reinforcement member 21 and the driving board 15 are connected, a separation region s may be formed between the leg portions 213, the body portion 211 and the driving board 15. The connection between the reinforcement member 21 and the driving board 15 will be discussed in more detail with respect to FIG. 4 below.

Without intending to be bound by theory, it should also be noted that the separation region s may provide improved electrical connection between the plasma display device components and enhance their operation. In particular, it is believed that the separation region s formed between the leg portions 213, the body portion 211 and the driving board 15 upon connection between the reinforcement member 21 and the driving board 15 may reduce a physical proximity, i.e., proximity other than intentional electrical connection, between the print circuit pattern 217 of the reinforcement member 21 and any circuit elements or print circuit patterns of the driving board 15, thereby preventing contact therebetween, and, consequently, eliminating a potential for a short circuit.

The print circuit pattern 217 of the reinforcement member 21 may be formed on the body portion 211 and on at least one leg portion 213 of at least one supporting member of the pair of first supporting members 121, as further illustrated in FIG. 3. The print circuit pattern 217 may be connected to a print circuit pattern formed on the driving board 15 via the terminal portion 215. The print circuit pattern 217 may be formed of a copper wire in any shape, e.g., a closed loop, and by any method known in the art, e.g., deposition, on either one or on all the supporting members 121 and 221.

In this respect, it should be noted that even though an exemplary structure of one supporting member of the pair of first supporting members 121 of the reinforcement member 21 was illustrated with respect to FIG. 3, a similar structure and/or elements may correspond to the pair of the second supporting members 221 and a second supporting member of the pair of first supporting members 121 of the reinforcement member 21.

As discussed previously, the reinforcement member 21 may be connected to the driving board 15 via at least one terminal portion 215. In particular, the at least one terminal portion 215 may be coupled between at least one leg portion 213 and the driving board 15. More specifically, the at least one terminal portion 215 may be inserted into a bonding hole 171 of the driving board 15 and soldered therein, such that the reinforcement member 21 may be attached to the driving board 15, as illustrated in FIG. 4. Further, upon insertion into the bonding hole 171, the terminal portion 215 may electrically connect the print circuit pattern 217 of the reinforcement member 21 to a ground circuit pattern 173 included in the driving board 15, as further illustrated in FIG. 4. The ground circuit pattern 173 may be connected to the chassis base 17 via the bolt 19, such that the chassis base 17 may be used as a ground.

If the print circuit pattern 217 of the reinforcement member 21 and the ground circuit pattern 173 are electrically connected, the print circuit pattern 217 may be used as a print circuit pattern for ground. For example, a circuit element 30 may be mounted on the driving board 15 and electrically connected to the bonding hole 171, as illustrated in FIG. 4. The electrical connection of the circuit element 30 to the bonding hole 171 may further electrically connect the circuit element 30 to the chassis base 17 via the ground circuit pattern 173 and through the print circuit pattern 217 of the reinforcement member 21, thereby grounding the circuit element 30.

Since a ground circuit may be formed through the print circuit pattern 217 in addition to the ground circuit pattern 173 formed on the driving board 15, an area allocated for forming the ground circuit pattern 173 of the driving board 15 may be minimized. In other words, forming a ground circuit through the print circuit pattern 217 may provide a ground current in the yz-plane through the driving board 15, i.e., ground circuit pattern 173, and in the xz-plane through the reinforcement member 21, i.e., print circuit pattern 217, such that the area of occupied by the ground circuit pattern 173 may be reduced, thereby providing additional space on the driving board 15 for other print circuit patterns. For example, an area employed for mounting the print circuit pattern required for driving the plasma display panel can be increased on the driving board 15, thereby providing enhanced stability of a driving signal transmitted from the driving board 15 to the PDP 11.

Without intending to be bound by theory, it is believed that absence of the reinforcement member 21 would have required formation of all ground circuit patterns on the driving board 15. Such structure of the driving board 15 would have minimized the space employed for forming the print circuit pattern transmitting the driving signal to the PDP 11, thereby reducing its stability as compared to the signal stability provided by the present invention.

As further illustrated in FIG. 4, the reinforcement member 21 may include a surface 214 positioned in the yz-plane, i.e., parallel to the driving board 15.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel;
a chassis base coupled to the plasma display panel;
a driving board having a plurality of circuit elements and mounted on the chassis base; and
at least one reinforcement member mounted on the driving board,
wherein the reinforcement member extends in one direction such that the driving board is prevented from bending.

2. The device as claimed in claim 1, wherein the at least one reinforcement member comprises a pair of first supporting members which are parallel to one another.

3. The device as claimed in claim 1, wherein the reinforcement member comprises a surface parallel to a planar surface direction of the driving board.

4. The device as claimed in claim 2, wherein the at least one reinforcement member further comprises a pair of second supporting members.

5. The device as claimed in claim 4, wherein a length of the first supporting members is longer than a length of the second supporting members.

6. The device as claimed in claim 4, wherein the pair of first supporting members is positioned in a plane perpendicular to a plane of the pair of second supporting members.

7. The device as claimed in claim 4, wherein the pair of first supporting members and the pair of second supporting members are arranged in a tetragon.

8. The device as claimed in claim 2, wherein the pair of first supporting members is parallel to a side of the driving board.

9. The device as claimed in claim 2, wherein each of the first supporting members is positioned along an edge of the driving board.

10. The device as claimed in claim 9, wherein a length of each of the first supporting members is less than or about equal to a length of the edge.

11. The device as claimed in claim 9, wherein a pair of second supporting members is positioned on the driving board, the pair of second supporting members being perpendicular to the pair of the first supporting members.

12. The device as claimed in claim 1, wherein the reinforcement member is positioned in a plane perpendicular to a plane of the driving board.

13. The device as claimed in claim 1, wherein the reinforcement member comprises a plurality of leg portions.

14. The device as claimed in claim 13, wherein at least two of the plurality of leg portions are positioned at respective ends of the reinforcement member and connected to the driving board.

15. The device as claimed in claim 14, wherein at least one of the plurality of leg portions is positioned between the respective ends of the reinforcement member.

16. The device as claimed in claim 13, wherein the reinforcement member further comprises at least one terminal portion coupled to at least one of the leg portions and electrically connected to the driving board.

17. The device as claimed in claim 13, wherein the reinforcement member further comprises a separation space between the plurality of leg portions, the driving board, and a body of the reinforcement member.

18. The device as claimed in claim 1, wherein the reinforcement member comprises a print circuit pattern.

19. The device as claimed in claim 18, wherein the circuit element is grounded through the print circuit pattern.

20. The device as claimed in claim 19, wherein a three-dimensional ground current flow is ensured through the driving board and the reinforcement member.
